(19) United States
(12) Patent Application Publication
(10) Pub. No.: US 2026/0349111 A1
(43) Pub. Date: Nov. 5, 2026

(54) FAST ULTRASOUND IMAGING METHOD FOR MOTION DETECTION USING COMB DETECTION BEAMS

(71) Applicant: Mayo Foundation for Medical Education and Research, Rochester, MN (US)

(72) Inventors: Matthew W. Urban, Rochester, MN (US); Hyungkyi Lee, Rochester, MN (US); James F. Greenleaf, Rochester, MN (US)

(21) Appl. No.: 19/118,080

(22) PCT Filed: Oct. 3, 2023
(86) PCT No.: PCT/US2023/075812

§ 371 Date: Apr. 3, 2025

Related U.S. Application Data
(60) Provisional application No. 63/412,856, filed on Oct. 3, 2022.

(51) Int. Cl. G01S 15/89; G01S 7/52

(52) U.S. Cl. CPC G01S 15/8927; G01S 7/5209; G01S 15/8925; G01S 15/8995

(57) ABSTRACT

A comb beam detection transmit scheme is used to significantly increase the frame rate in ultrasound imaging. The comb beam detection is based on simultaneous transmission of several ultrasound beam sets (e.g., sets of focused ultrasound beams) that are spatially arranged in a comb shaped beam pattern over the ultrasound transducer, and scanning these beams in space. For example, to cover an entire region-of-interest, the comb beams are translated along the lateral axis and transmitted at consecutive times. After the scanning, a compounded image is generated from the ultrasound data acquired across the different time frames (i.e., from the different spatial offsets of the comb beam pattern).

### STATEMENT OF FEDERALLY SPONSORED RESEARCH

This invention was made with government support under HL145268 awarded by the National Institutes of Health. The government has certain rights in the invention.

### BACKGROUND

Fast ultrasound imaging enables a number of applications. However, current methods suffer from low signal-to-noise ratio (“SNR”).

Since plane wave imaging (“PWI”) was introduced two decades ago for tracking shear wave propagation, it has been utilized for many other applications including B-mode imaging, pulse wave imaging, Doppler imaging, microvascular imaging for functional ultrasound, and quantitative ultrasound. One of the primary benefits of PWI is the high frame rate, which is limited only by the imaging depth. However, using unfocused plane wave transmits leads to poorer image quality mainly due to a reduction in echo SNR.

One approach to improve the SNR using PWI is to use multiple angled plane wave transmissions. Then, the received echoes are coherently summed or compounded in a technique known as plane wave compounding (“PWC”). PWC can achieve high image quality comparable to the multifocal imaging method, but it requires more than 70 transmits at different angles, which leads to the slow frame rate. There is a tradeoff between the fast frame rate and high image quality in PWC.

For some applications, which do not require the high frame rate, line-by-line scanning using a focused transmit beam is widely utilized. Most commercial ultrasound imaging uses this method to construct B-mode images. This method provides high image quality, but it suffers from slow frame rate.

Thus, there remains a need for fast ultrasound imaging techniques that do not suffer from the lower SNR of current high frame rate imaging techniques.

### SUMMARY OF THE DISCLOSURE

The present disclosure addresses the aforementioned drawbacks by providing a method for ultrasound imaging that includes acquiring ultrasound data from a region-of-interest in a subject with an ultrasound system by controlling the ultrasound system according to a detection sequence. In each of a plurality of transmission events, the detection sequence includes transmitting a comb beam set containing a plurality of ultrasound beam sets spaced apart along a spatial dimension of an ultrasound transducer of the ultrasound system, and acquiring an ultrasound data set from a set of spatial locations in the region-of-interest corresponding to the transmitted comb beam set. The comb beam set is shifted along the spatial dimension of the ultrasound transducer in different ones of the plurality of transmission events such that a different ultrasound data set is acquired from a different set of spatial locations in the region-of-interest. An image is generated from the ultrasound data by combining ultrasound data sets acquired at different sets of spatial locations.

It is another aspect of the present disclosure to provide an ultrasound system that includes an ultrasound transducer, a transmitter configured to control the ultrasound transducer to generate ultrasound, a receiver configured to receive ultrasound data measured by the ultrasound transducer, and a controller in communication with the transmitter and the receiver. The controller is programmed to: control the transmitter, subject to a detection sequence, to cause the ultrasound transducer to generate a comb beam set comprising a plurality of ultrasound beam sets spaced apart along a spatial dimension of the ultrasound transducer so as to direct the ultrasound beam sets towards a first plurality of spatial locations in a region-of-interest; control the receiver, subject to the detection sequence, to acquire first ultrasound data measured from the first plurality of spatial locations; control the transmitter, subject to the detection sequence, to shift the comb beam set along the spatial dimension of the ultrasound transducer and to cause the ultrasound transducer to generate the comb beam set comprising the plurality of ultrasound beam sets so as to direct the ultrasound beam sets towards a second plurality of spatial locations that are shifted along the spatial dimension relative to the first plurality of spatial locations; and control the receiver, subject to the detection sequence, to acquire second ultrasound data measured from the second plurality of spatial locations.

The foregoing and other aspects and advantages of the present disclosure will appear from the following description. In the description, reference is made to the accompanying drawings that form a part hereof, and in which there is shown by way of illustration one or more embodiments. These embodiments do not necessarily represent the full scope of the invention, however, and reference is therefore made to the claims and herein for interpreting the scope of the invention.

### BRIEF DESCRIPTION OF THE DRAWINGS

FIG. 1 illustrates the concept of plane wave compounding. Each transmit generates a relative low-quality image and summing these three images coherently makes a compounded image with increased image quality.

FIG. 2A depicts comb beams that are transmitted simultaneously. Multiple image lines (dashed lines) are acquired.

FIG. 2B illustrates comb beams that are scanned in space to cover the entire region-of-interest.

FIGS. 3A-3C illustrate another example of a comb beam set being translated along a spatial dimension of an ultrasound transducer (e.g., the lateral dimension) in subsequent transmission events in order to acquired ultrasound data from different spatial locations in each transmission event.

FIGS. 3D and 3E illustrate an example of delaying the transmission of comb beams without overlaps (FIG. 3D) or such that some comb beams are at least partially overlapping in space (FIG. 3E) to provide temporal encoding.

FIG. 4 shows a pressure field of three comb transmit (Tx) patterns as an example. These three transmits are fired sequentially to generate an image.

FIG. 5 is a flowchart setting forth the steps of an example method for generating one or more images with an ultrasound system using the comb beam detection sequences described in the present disclosure.

FIGS. 6A and 6B illustrate simulation results using Field II. Scatterers are positioned in a line (z=20.7 mm).

FIGS. 7A and 7B show B-mode images acquired using comb detection (FIG. 7A) and PWC (FIG. 7B). A tube phantom was scanned using an ultrasound scanner.

FIG. 8 shows M-mode of motion at x=17.7 mm. A shear wave is generated at x=9 mm using the acoustic radiation force.

FIG. 9A is a B-mode image of a human carotid artery obtained using comb detection.

FIG. 9B depicts motion profiles over time at pixels marked as with a red arrow in FIG. 9A. Comb detection shows less variance than PWC because of the higher SNR of focused beam transmit.

FIG. 10 is a block diagram of an example ultrasound system that can implement the methods described in the present disclosure.

### DETAILED DESCRIPTION

Described here are systems and methods for ultrasound imaging using a comb detection transmit scheme to significantly increase the frame rate in the framework of focused beam transmit. In general, the comb detection technique is based on simultaneous transmission of several focused beams (e.g., in a comb-shaped beam pattern) and scanning these beams in space. For example, to cover an entire region-of-interest, the comb beams are translated along the lateral axis and transmitted at consecutive times. After the scanning, a compounded image is generated from the ultrasound data acquired across the different time frames (i.e., from the different spatial offsets of the comb beam pattern).

Advantageously, comb detection shows less variance than plane wave compounding (“PWC”). The transmit beam profile of comb detection is narrower than that of PWC, and it leads to a sharp two-way beam profile (which is the convolution of the transmit beam by the receive beam profile), which results in an improvement in signal-to-noise ratio (“SNR”). Comb detection is feasible for high frame rate imaging and takes advantage of focused beams for higher SNR.

The systems and methods described in the present disclosure can utilize the comb-shaped beams to measure motion, or other phenomena, occurring in the region-of-interest from which ultrasound data are acquired. Advantageously, the motion or other phenomena can be observed as a high frame rate using the systems and methods described in the present disclosure. In this way, the ultrasound data can be indicative of the motion occurring in the region-of-interest, or can otherwise comprise measurements of the motion occurring in the region-of-interest. The systems and methods described in the present disclosure can, therefore, be used in applications such as shear wave elastography, strain imaging, flow imaging, tissue motion tracking, microbubble tracking, or other object tracking. As one non-limiting example, the motion may be one or more shear waves propagating in the region-of-interest, such that the propagation of the shear wave(s) (e.g., in shear wave elastography techniques) can be observed or otherwise measured at high frame rate. Regarding shear wave detection, all of the data from a single shear wave propagation experiment can be measured for a full region-of-interest. The multiple beams for the comb detection are transmitted simultaneously instead of in a sequential manner. The comb can then be moved to a different set of positions for interrogation to cover the whole ROI.

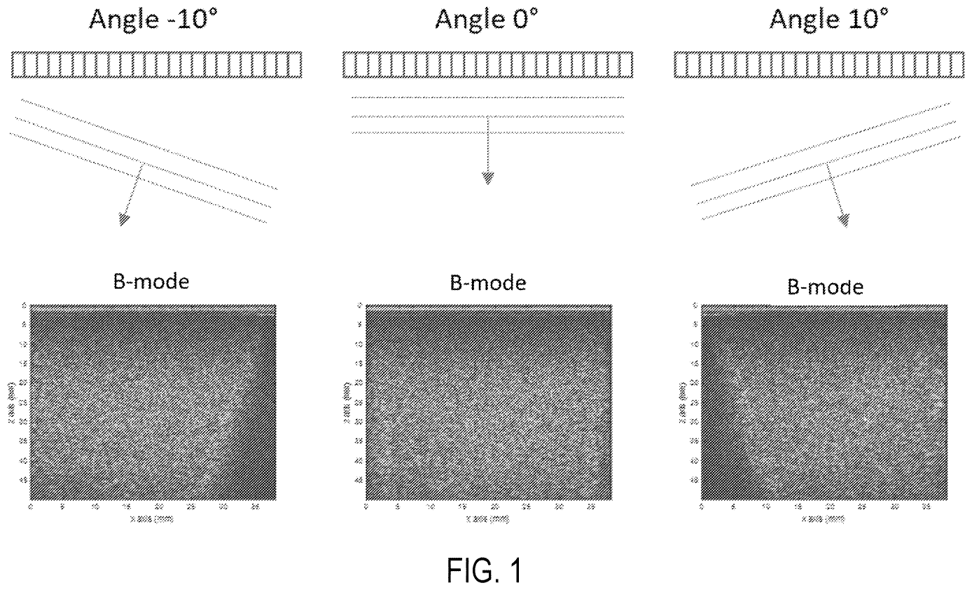

As discussed above, the conventional method of fast ultrasound acquisition is to utilize PWC. PWC transmits plane waves with different angles and the received signals are processed through a beamforming algorithm. FIG. 1 illustrates the concept of PWC with angled transmission. In this example, three angled transmissions are illustrated with angles of −10°, 0°, and 10°. The three transmits are used to generate a compounded image. Because PWC can be implemented with as few as three transmission angles, PWC allows for high frame rate acquisitions. However, conventional PWC methods have reduced SNR, as described above.

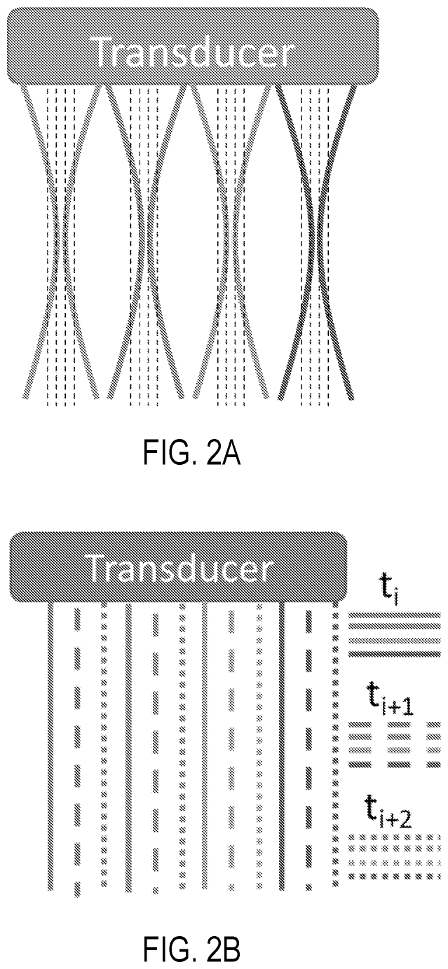

Comb detection uses a series of focused beams transmitted simultaneously, as shown in FIGS. 2A and 2B. In FIG. 2A, dashed lines represent the formed image lines, which are a portion of the region-of-interest (“ROI”). To cover the entire ROI, these comb beams are translated along the lateral axis and transmitted at consecutive times, as shown in FIG. 2B. The different locations of the comb beams are denoted with different types of lines. After the scanning, a compounded image is generated.

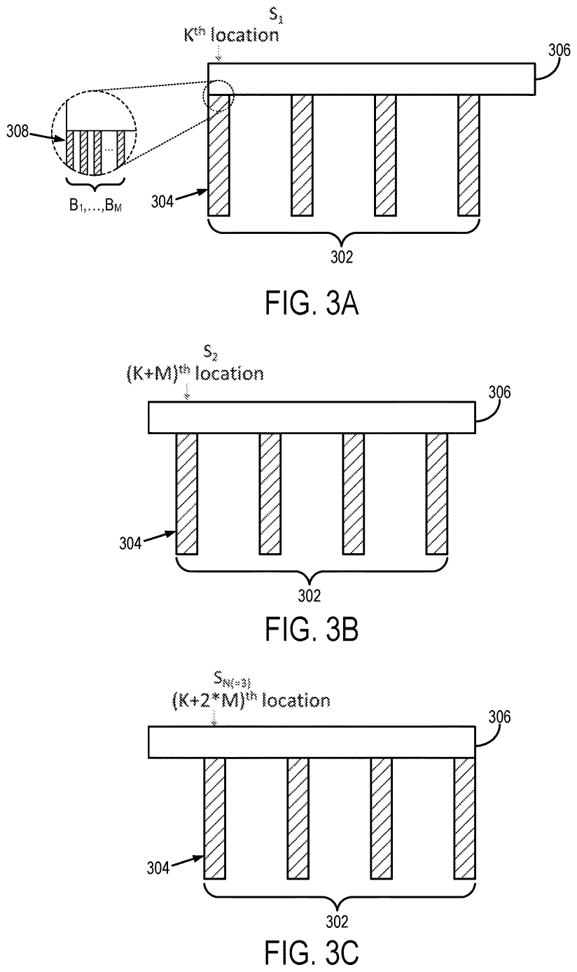

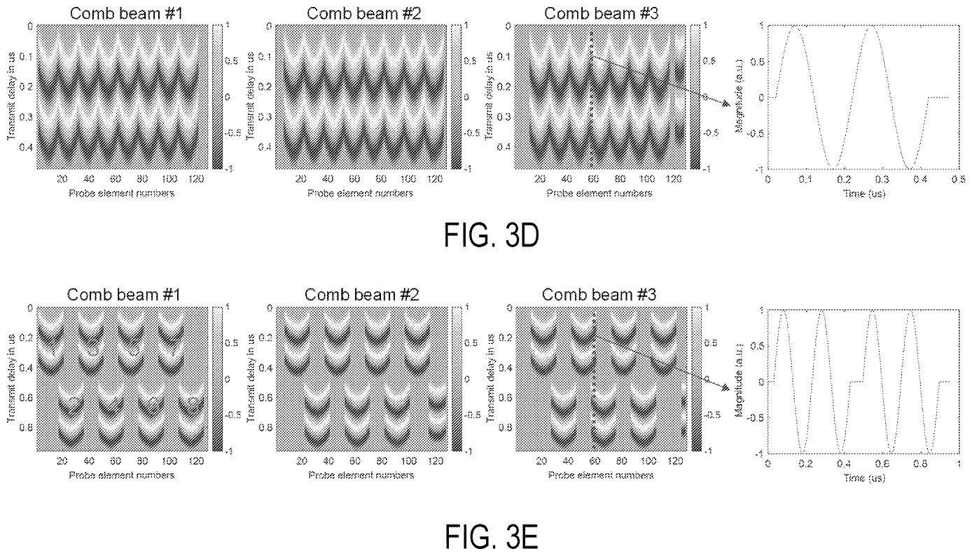

FIGS. 3A-3C illustrate another example of a comb detection sequence in accordance with some embodiments described in the present disclosure. At each time point, a different transmission of a comb beam set 302 of focused ultrasound beam sets 304 is generated. In general, the comb detection sequence includes N comb beam sets 302, S₁, S₂, . . . , S_{N}, with each comb beam set 302 being transmitted relative to a different spatial location or position of the ultrasound transducer (i.e., using a different set of transducer elements of the transducer 306). Each comb beam set 302 is composed of C focused ultrasound beam sets 304, each composed of M focused ultrasound beams 308, B₁, B₂, . . . , B_{M}, formed in parallel. In the illustrated example, the comb beam set 302 includes C=4 focused ultrasound beams 304, which is translated to N=3 different spatial locations during the sequence. The focused ultrasound beam sets 304 in the comb beam set 302 may be uniformly distributed (e.g., the focused ultrasound beam sets 304 can be equally spaced apart), or may be non-uniformly distributed on the transducer array. For instance, in some embodiments, it may be preferential to have a higher sampling density in certain spatial regions, so the focused ultrasound beam sets 304 can be spaced closer together in those regions.

In general, M×N×C spatial locations are covered by the comb detection sequence. This sequence can also be repeated at the pulse repetition frequency for a number, P, of desired repetitions. It will be appreciated that in some implementations, each focused ultrasound beam set 304 can include a single focused ultrasound beam 308 (i.e., M=1). Additionally or alternatively, the focused ultrasound beam sets 304 may instead include one or more unfocused ultrasound beams.

The different sets are transmitted at different time points, or in different time frames, with each subsequent comb beam set 302 being spatially shifted relative to the previous cone beam set 302. In the illustrated embodiments, a first comb beam set 302, S₁, is transmitted at a first time point (FIG. 3A), a second comb beam set 302, S₂, is transmitted at a second time point (FIG. 3B), and a third comb beam set 302, S₃, is transmitted at a third time point (FIG. 3C).

Each of the different comb beam sets 302 are translated along the lateral axis of the ultrasound transducer 306 relative to each other. For instance, the first comb beam set 302, S₁, is transmitted relative to a first spatial location, k (FIG. 3A); the second comb beam set 302, S₂, is transmitted relative to a second spatial location, k+M (FIG. 3B); and the third comb beam set 302, S₃, is transmitted relative to a third spatial location, (k+2·M) (FIG. 3C).

As noted above, each set comb beam set 302, Sₙ, can include a plurality of focused ultrasound beam sets 304, each composed of a plurality of ultrasound beams 308, Bₘ, that are formed in parallel. For example, each set of focused ultrasound beams 304 may include four beams 308 formed in parallel.

In one configuration, such as the configuration illustrated in FIGS. 3A-3C, the transducer elements are divided into a number of subgroups, such as four subgroups, that each simultaneously transmits a plurality of focused ultrasound beam sets 304. The transducer elements are divided into a number, C, of subgroups, with each subgroup containing one or more transducer elements. As one example, the ultrasound transducer 306 can be divided into three subgroups, S₁, S₂, S₃, each containing C=4 focused beam sets with M focused ultrasound beams formed in parallel. Thus, the ultrasound transducer 306 may be subdivided into N×C subgroups of transducer elements, such that no transducer element is energized twice during the detection sequence. Additionally or alternatively, the transducer elements in a given comb beam set 302 can be divided into a number of subgroups with overlapping elements. In these implementations, the duration of each comb beam set 302 can be selected based on considerations for how much overlap there is between subgroups of the transducer elements. For instance, the duration can be selected such that any given transducer element in overlapping subgroups is not energized for a consecutive duration that may lead to overheating in that element. Pulses can be temporally encoded as described below for the transmission system. Temporally encoded signals can be used on overlapping elements such that part of the signals is for a first comb beam (e.g., comb beam S₁) and a later part of the signal is for a second comb beam (e.g., comb beam S₂). An example of such temporal encoding is illustrated in FIGS. 3D and 3E, where FIG. 3D shows using transmit delays without overlaps, and FIG. 3E shows using transmit delays with overlaps that provide temporal encoding. Alternatively, for each comb beam set 302, the transmit apertures (e.g., firing transducer elements) may not have any overlaps.

After the first comb beam set 302 is transmitted, a second comb beam set 302 is transmitted at a second time, t₂, using the second subgroup of transducer elements. This continues for the third and any other subsequent subgroups. There may be a small duration between the transmission of consecutive comb beam sets 302.

In some alternative configurations, each comb beam set 302 may have a different number of transmit elements and/or may include focused ultrasound beam sets 304 and/or focused ultrasound beams 308 that are focused at different depths. It is also noted that the comb beam sets 302 can have different durations and can be transmitted in an arbitrary order. Thus, while FIGS. 3A-3C illustrate a sequential ordering in which comb beam sets 302 are sequentially translated along the lateral dimension as 1→2→3, in other embodiments the comb beam sets 302 can be translated as 1→3→2; 2→1→3; 2→3→1; 3→1→2; 3→2→1; or any other combination or ordering.

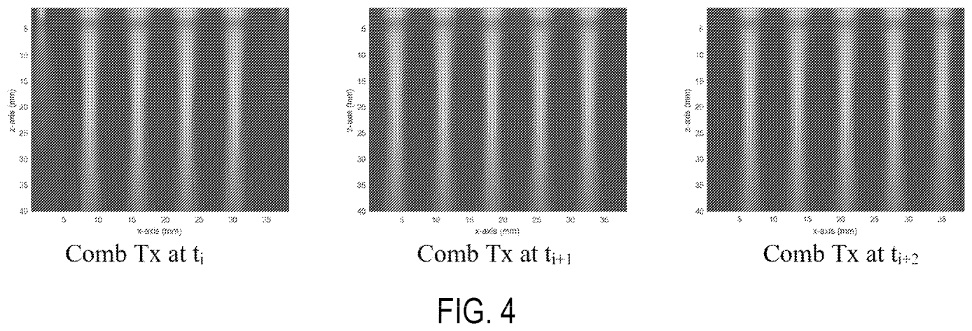

FIG. 4 shows a simulated pressure field within an image plane generated from comb beam set transmits. The parameters for the transmits in this example are transmit frequency: 5 MHz, transmit wave cycles: 2, transmit F #: 4, transmit apodization filter: 25 elements with rectangular window. These three transmits are fired sequentially to make an image.

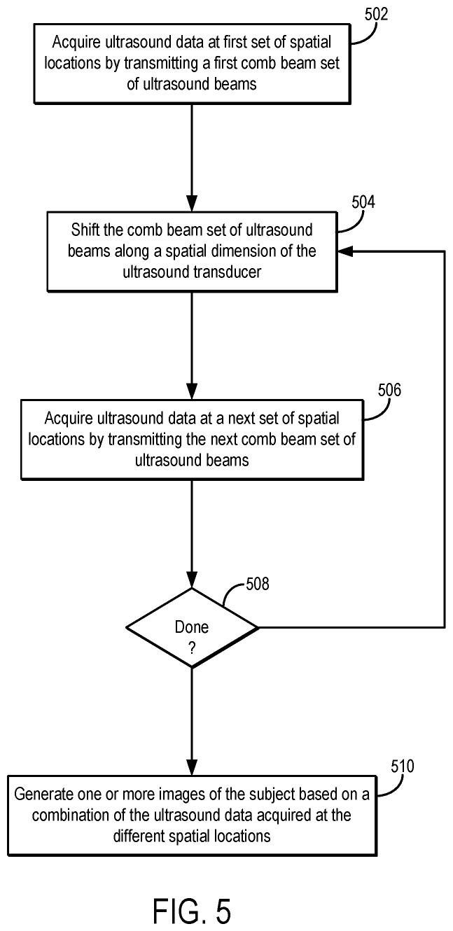

Referring now to FIG. 5, a flowchart is illustrated as setting forth the steps of an example method for generating one or more images of a subject using a comb beam detection acquisition scheme. The method includes acquiring ultrasound data at a first set of spatial locations by transmitting a first comb beam set of ultrasound beams, as indicated at step 502. For example, a comb beam set S₁ of C ultrasound beam sets, each containing M ultrasound beams can be transmitted at the first set of spatial locations. The ultrasound beam sets may include focused ultrasound beams formed in parallel, unfocused ultrasound beams, or the like. Each ultrasound beam set may also include a single ultrasound beam (M=1), or a plurality of ultrasound beams (M>1). In some embodiments, the comb beam sets are transmitted after inducing a shear wave in the subject, such that the acquired ultrasound data are representative of one or more shear waves propagating in the imaged region-of-interest of the subject (e.g., at the measured spatial locations).

The comb beam pattern is then shifted along a spatial dimension of the ultrasound transducer, as indicated at step 504. For example, the comb beam set can be translated along the lateral dimension of the ultrasound transducer, such that the next comb beam set is transmitted by a different set, or subgroup, of transducer elements. The next comb beam set is then transmitted to acquire ultrasound data from the next set of spatial locations in the region-of-interest, as indicated at step 506. This process is then repeated, as indicated by decision block 508, until the desired spatial locations have been measured. In some other embodiments, the comb beam set need not be spatially shifted, or scanned. These implementations are advantageous when an even higher frame rate may be desirable. Although the acquired ultrasound data in these instances will include imaging lines that cover only a portion of the region-of-interest, this increase in attainable frame rate is an advantageous tradeoff when more limited spatial coverage is acceptable (e.g., for smaller anatomical target, for measuring motion in a specific spatial region, and so on).

After the desired spatial locations have been measured, one or more images are generated from the ultrasound data acquired from those spatial locations, as indicated at step 510. For example, an image can be generated based on a combination of the ultrasound data acquired at different spatial locations using different comb beam sets. As a non-limiting example, an image generation process similar to compounding can be utilized. In one such example, an image is reconstructed from the data acquired in each transmission event and the resulting images are combined to form the final image.

The generated images can then be displayed to a user, or stored for later use or processing. For example, when the ultrasound data are acquired while a shear wave is propagating the region-of-interest, the images can be processed to estimate a mechanical property and/or to generate a mechanical property map that depicts a spatial distribution of mechanical properties in the region-of-interest.

It should be noted that the systems and methods described in the present disclosure can be extended to a higher dimension array transducer, such as a multi-row array or a matrix array. In these instances, the comb detection beams can be distributed or otherwise arranged in the lateral dimension of the transducer array, the elevational dimension of the transducer array, or a combination of both the lateral and elevational transducer array. The comb detection beams can thus be shifted in each of these dimensions, or in both of these dimensions, for subsequent transmissions.

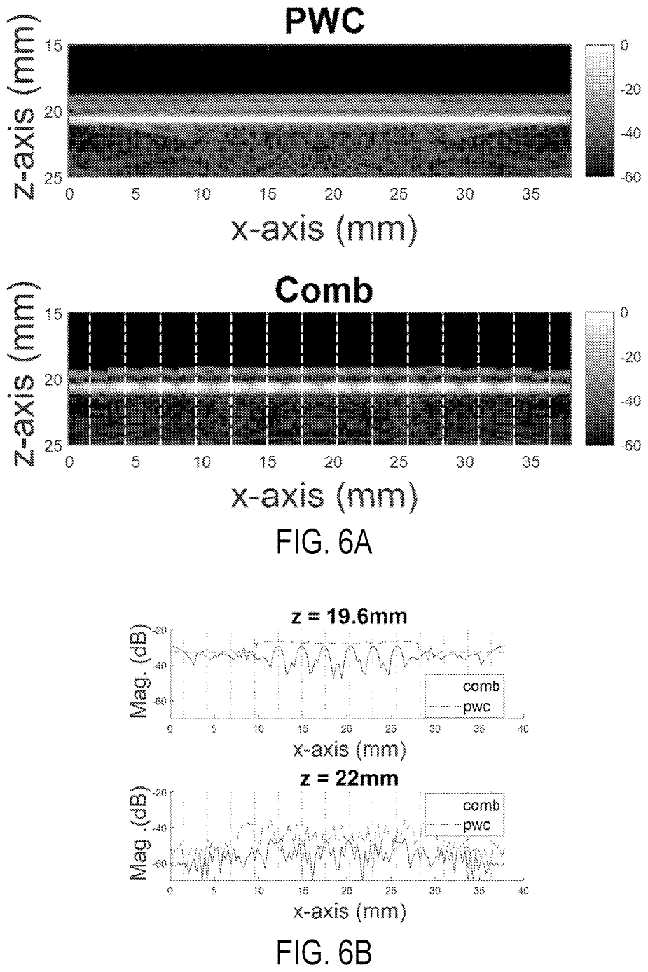

In an example study, the comb detection techniques described in the present disclosure were compared with PWC, simulation (using Field II), phantom and in vivo studies. A Verasonics system (V1, Verasonics, Inc., Kirkland, WA) with a 128 element linear probe (L7-4, Philips Healthcare, Andover, MA) was used for acquiring experimental data. The comb beams were scanned three times and compared with PWC with three angles (−4°, 0°, 4°), which provides the same frame rate. FIGS. 6A and 6B show simulated B-mode images using PWC and comb detection to scan a set of point scatterers positioned in a line (z=20.7 mm), respectively. Artifacts are shown above and below the line. The vertical yellow lines denote the center of comb beams in the lateral dimension. FIG. 6B shows the profiles at z=19.6 and 22.0 mm, where the artifacts appear. Comb detection was observed to outperform PWC in terms of artifact suppression.

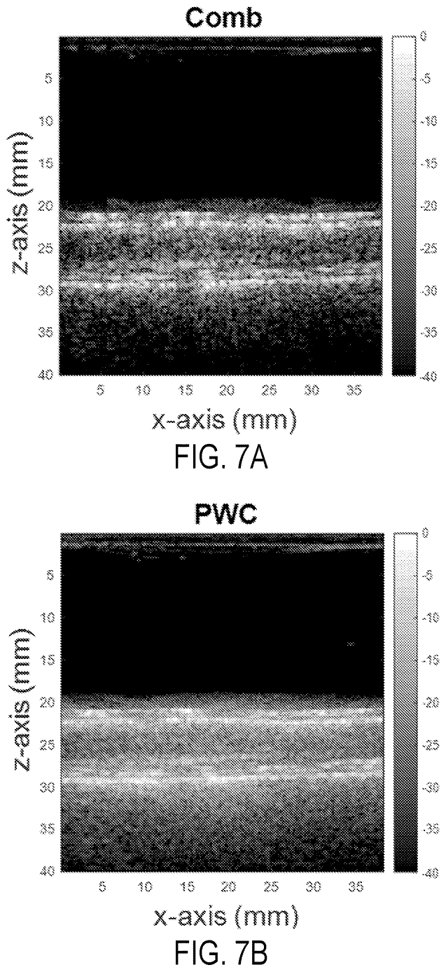

FIGS. 7A and 7B show B-mode images of a tube phantom using comb detection (FIG. 7A) and PWC (FIG. 7B). A urethane rubber tube (VytaFlex™ 30, SmoothOn, Inc., Macungie, PA) was made in a custom-made mold. The inner radius of the tube was 3 mm and the wall thickness was 1 mm. It was immersed in a degassed water tank and filled with water.

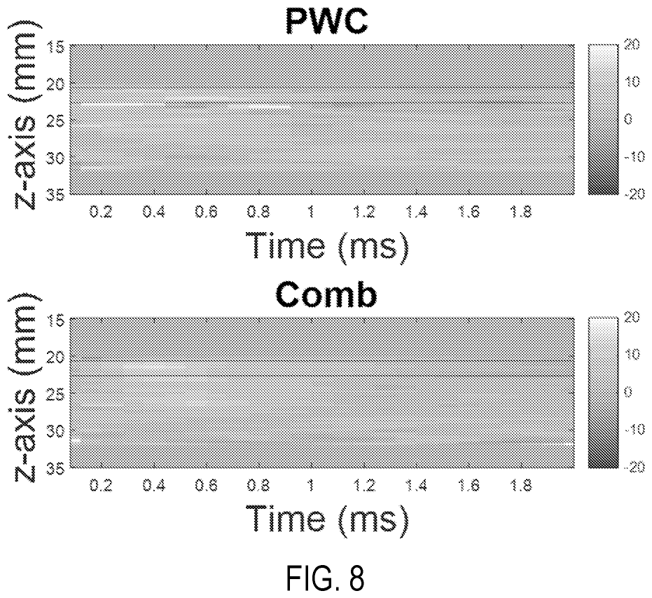

To examine the performance of motion estimation using the comb detection techniques, a shear wave was generated at x=9 mm in the x-axis using an acoustic radiation force (“ARF”), and in-phase/quadrature (IQ) data of 140 frames were saved with the frame rate of 12.5 kHz. An autocorrelation method was used to calculate the phase change between two consecutive IQ data frames. At x=17.7 mm of FIGS. 7A and 7B, an M-mode of the motion from PWC and comb detection is shown in FIG. 8. Solid lines denote the top wall of the tube. Comb detection showed more consistency through the depth of the tube wall than PWC.

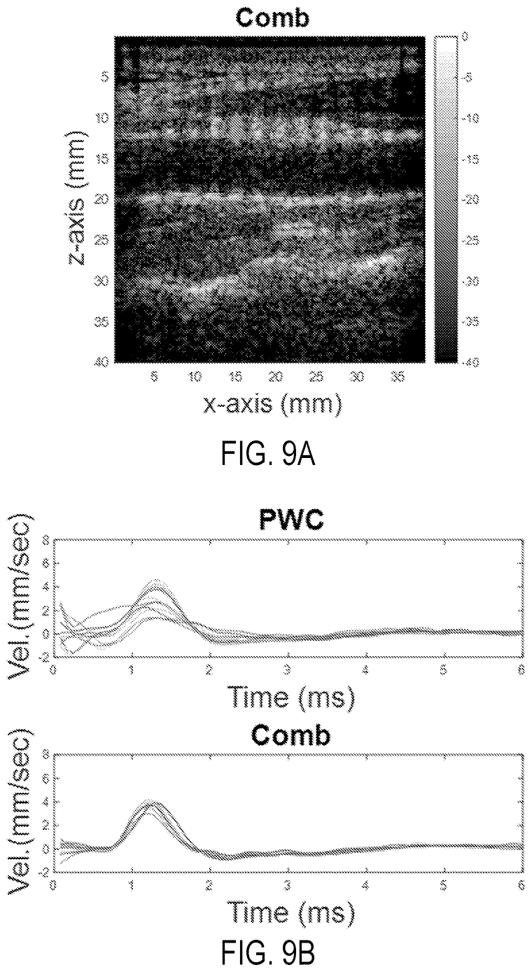

FIG. 9A shows a B-mode image of in vivo carotid artery of 55 year-old male subject. Motion is measured at x=15 mm after the wave is generated using ARF. At 11 different depths denoted as the red arrow, the motion profiles over time are plotted in FIG. 9B. Comb detection showed less variance than PWC. It is an advantage of the comb beam detection techniques described in the present disclosure that this improved data acquisition can be realized. The transmit beam profile of comb detection is narrower than that of PWC, which leads to a sharp two-way beam profile (which is the convolution of the transmit beam by the receive beam profile) and this improves SNR. Comb detection is feasible for high frame rate imaging and takes advantage of focused beams for higher SNR.

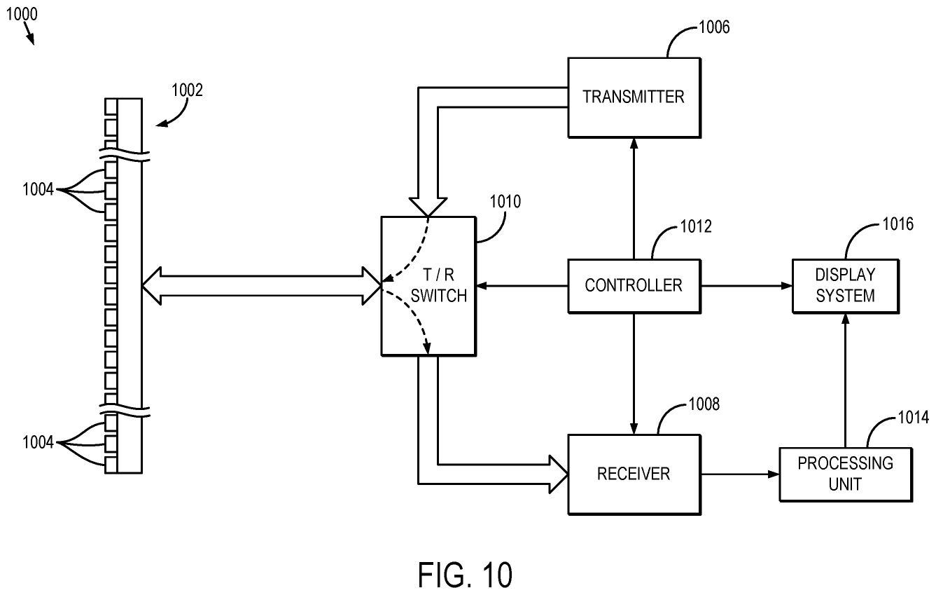

FIG. 10 illustrates an example of an ultrasound system 1000 that can implement the methods described in the present disclosure. The ultrasound system 1000 includes a transducer array 1002 that includes a plurality of separately driven transducer elements 1004. The transducer array 1002 can include any suitable ultrasound transducer array, including linear arrays, curved arrays, phased arrays, and so on. Similarly, the transducer array 1002 can include a 1D transducer, a 1.5D transducer, a 1.75D transducer, a 2D transducer, a 3D transducer, and so on.

When energized by a transmitter 1006, a given transducer element 1004 produces a burst of ultrasonic energy. The ultrasonic energy reflected back to the transducer array 1002 (e.g., an echo) from the object or subject under study is converted to an electrical signal (e.g., an echo signal) by each transducer element 1004 and can be applied separately to a receiver 1008 through a set of switches 1010. The transmitter 1006, receiver 1008, and switches 1010 are operated under the control of a controller 1012, which may include one or more processors. As one example, the controller 1012 can include a computer system.

The transmitter 1006 can be programmed to transmit unfocused or focused ultrasound waves. In some configurations, the transmitter 1006 can also be programmed to transmit diverged waves, spherical waves, cylindrical waves, plane waves, or combinations thereof. Furthermore, the transmitter 1006 can be programmed to transmit spatially or temporally encoded pulses.

The receiver 1008 can be programmed to implement a suitable detection sequence for the imaging task at hand. In some embodiments, the detection sequence can include one or more of line-by-line scanning, compounding plane wave imaging, synthetic aperture imaging, and compounding diverging beam imaging.

In some configurations, the transmitter 1006 and the receiver 1008 can be programmed to implement a high frame rate. For instance, a frame rate associated with an acquisition pulse repetition frequency (“PRF”) of at least 100 Hz can be implemented. In some configurations, the ultrasound system 1000 can sample and store at least one hundred ensembles of echo signals in the temporal direction.

The controller 1012 can be programmed to design, or otherwise implement, an imaging sequence using the comb detection techniques described in the present disclosure. In some embodiments, the controller 1012 receives user inputs defining various factors used in the design of the imaging sequence.

A scan can be performed by setting the switches 1010 to their transmit position, thereby directing the transmitter 1006 to be turned on momentarily to energize transducer elements 1004 during a single transmission event according to the prescribed imaging sequence. The switches 1010 can then be set to their receive position and the subsequent echo signals produced by the transducer elements 1004 in response to one or more detected echoes are measured and applied to the receiver 1008. The separate echo signals from the transducer elements 1004 can be combined in the receiver 1008 to produce a single echo signal.

The echo signals are communicated to a processing unit 1014, which may be implemented by a hardware processor and memory, to process echo signals or images generated from echo signals. As an example, the processing unit 1014 can reconstruct images using the methods described in the present disclosure. Images produced from the echo signals by the processing unit 1014 can be displayed on a display system 1016.

The present disclosure has described one or more preferred embodiments, and it should be appreciated that many equivalents, alternatives, variations, and modifications, aside from those expressly stated, are possible and within the scope of the invention.

1. A method for ultrasound imaging, the method comprising:
(a) acquiring ultrasound data from a region-of-interest in a subject with an ultrasound system by controlling the ultrasound system according to a detection sequence to, in each of a plurality of transmission events:
transmit a comb beam set comprising a plurality of ultrasound beam sets spaced apart along a spatial dimension of an ultrasound transducer of the ultrasound system;
acquire an ultrasound data set from a set of spatial locations in the region-of-interest corresponding to the transmitted comb beam set; and
(b) generating an image from the ultrasound data.

2. The method of claim 1, wherein the comb beam set is shifted along the spatial dimension of the ultrasound transducer in different ones of the plurality of transmission events such that a different ultrasound data set is acquired from a different set of spatial locations in the region-of-interest.

3. The method of claim 2, wherein step (b) comprises generating the image by combining ultrasound data sets acquired at different sets of spatial locations.

4. The method of claim 2, wherein at least some of the comb beam sets are transmitted using transducer elements that at least partially overlap.

5. The method of claim 2, wherein each successively transmitted comb beam set is transmitted by a subgroup of transducer elements that is spatially adjacent to the subgroup of transducer elements that transmitted a previous comb beam set.

6. The method of claim 2, wherein the spatial dimension of the ultrasound transducer is a lateral dimension.

7. The method of claim 2, wherein the spatial dimension is a first spatial dimension and the detection sequence comprises, in each of the plurality of transmission events, shifting the comb beam set along at least one of the first spatial dimension and a second spatial dimension that is different from the first spatial dimension.

8. The method of claim 7, wherein the first spatial dimension is a lateral dimension and the second spatial dimension is an elevational dimension.

9. The method of claim 1, wherein the ultrasound data represent a plurality of time frames, and wherein the ultrasound system is controlled to repeat the detection sequence for the plurality of time frames.

10. The method of claim 9, wherein generating an image from the ultrasound data comprises generating a plurality of images from the ultrasound data, wherein each of the plurality of images corresponds to a different one of the plurality of time frames.

11. The method of claim 1, wherein each comb beam set comprises a plurality of ultrasound beams that are formed in parallel.

12. The method of claim 11, wherein each of the plurality of ultrasound beams is a focused ultrasound beam.

13. The method of claim 1, wherein step (a) includes transmitting a plurality of focused ultrasound beams into the subject with each comb beam set, each of the plurality of focused ultrasound beams being generated by a different subgroup of transducer elements.

14. The method of claim 13, wherein the plurality of focused ultrasound beams are evenly spaced apart within each ultrasound beam set.

15. The method of claim 1, wherein the plurality of ultrasound beam sets are spaced apart evenly within each comb beam set.

16. The method of claim 1, wherein the ultrasound data acquired from the region-of-interest in the subject are indicative of motion occurring in the region-of-interest while the ultrasound data were acquired.

17. The method of claim 16, further comprising inducing a shear wave in the subject and wherein the motion occurring in the region-of-interest comprises the shear wave propagating in the region-of-interest.

18. The method of claim 17, further comprising estimating a mechanical property from the image generated in step (b).

19. The method of claim 17, further comprising generating, from the image generated in step (b), a mechanical property map that depicts a spatial distribution of mechanical properties in the region-of-interest of the subject.

20. The method of claim 16, wherein the image generated in step (b) is used for one of strain imaging, flow imaging, tissue motion tracking, or object tracking.

21. The method of claim 20, wherein the object tracking comprises microbubble tracking.

22. The method of claim 1, wherein each ultrasound beam set consists of a single ultrasound beam.

23. An ultrasound system, comprising:
an ultrasound transducer;
a transmitter configured to control the ultrasound transducer to generate ultrasound;
a receiver configured to receive ultrasound data measured by the ultrasound transducer; and
a controller in communication with the transmitter and the receiver, wherein the controller is programmed to:
control the transmitter, subject to a detection sequence, to cause the ultrasound transducer to generate a comb beam set comprising a plurality of ultrasound beam sets spaced apart along a spatial dimension of the ultrasound transducer so as to direct the ultrasound beam sets towards a first plurality of spatial locations in a region-of-interest;
control the receiver, subject to the detection sequence, to acquire first ultrasound data measured from the first plurality of spatial locations;
control the transmitter, subject to the detection sequence, to shift the comb beam set along the spatial dimension of the ultrasound transducer and to cause the ultrasound transducer to generate the comb beam set comprising the plurality of ultrasound beam sets so as to direct the ultrasound beam sets towards a second plurality of spatial locations that are shifted along the spatial dimension relative to the first plurality of spatial locations; and
control the receiver, subject to the detection sequence, to acquire second ultrasound data measured from the second plurality of spatial locations.
